(19) United States
(12) Patent Application Publication
(10) Pub. No.: US 2007/0271584 A1
(43) Pub. Date: Nov. 22, 2007

(54) System for submitting and processing content including content for on-line media console

(75) Inventors: Darren L. Anderson, Sammamish, WA (US); James H. Miller, Seattle, WA (US); Michio Nikaido, Carnation, WA (US); Shaykat Chaudhuri, Sammamish, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/435,693

(22) Filed: May 16, 2006

(51) Int. Cl. H04N 7/173; H04N 7/16

(52) U.S. Cl. 725/86; 725/87; 725/133; 725/141; 725/153

(57) ABSTRACT

An intake interface receives a package with files of content from a submitter and places a job with the package in a jobs database. An automated dispatcher retrieves the job, identifies each file of the content of the package of the job, and groups the identified files into one or more tasks. Each task has a particular type and represents a particular propagation event that can be submitted to one or more particular tools. The automated dispatcher, for each task, calls to a propagation system with the files of the task and the particular type of the task. The propagation system calls to one or more particular tools thereof to in fact perform one or more respective propagating events based on the files and type of such task to propagate the content of the job to the network.

### TECHNICAL FIELD

The present invention relates to a system and method that are employed to submit content to be implemented at a network. More particularly, the present invention relates to such a system and method for submitting content that is to be employed in connection with a network that services and supports on-line media consoles, where the content as submitted is appropriately located to be accessible by the media consoles, is executed at the network to implement network-based functionality for the media consoles, and/or the like.

### BACKGROUND OF THE INVENTION

In connection with a media console computing device, such as for example a game-playing device, it is known that such device may be coupled to a network or the like to implement network-based functionality. With such network-based functionality, and as should be appreciated, a user at one device may take advantage of resources available at the network by for example downloading content from the network, rendering content available from the network, communicating with another user at another device, and the like. In one particular example, if the media console computing device is a game-playing device, the network-based functionality may correspond to a game the user has instantiated at the device from a source at the device, such as for example an optical disk with a copy of the software that the device runs to implement the game. Similarly, the network-based functionality may correspond to a game the user has instantiated at the device from a source at the network. In either case, the network may be a game-related network that provides content relating to the game, including content that implements additional game features such as personas, capabilities, levels, and the like. Similarly, the game-related network may provide content ancillary to the game such as audio, video, and/or multimedia presentations that a user of the game may find interesting, or may provide content that allows the user at the device to play the game with another user at another device by way of the network.

With such game-related network, then, a developer or the like may not only develop and provide a game to be employed in connection with the aforementioned game-playing device but in addition may provide content relating to the game by way of the game-related network, where the game-related content allows a user of the game to experience greater enjoyment and value in connection with such game. Notably, such developer or the like may provide any game-related content, including but not limited to game demos, movie trailers, gamer pictures, gamer themes and in-game content such as new maps, levels, tools, weapons, equipment, functionality, and the like.

Previously, game-related content would be submitted and mounted to the game-related network by a process that was generally manual in form. In particular, the developer or the like or an agent thereof would package the content into some appropriate form and submit same to an intake interface for the network, and an administrator or other person would then be provided with the package from the intake interface, after which such administrator or other person would perform whatever manual processes are necessary to mount or propagate the content of the package to the network. For example, if the content is a downloadable data file, the administrator or other person would place such content in an appropriate download location. Similarly, if the content is a network executable, the administrator or other person would run the executable at the network.

Typically, although not necessarily, a developer or the like can submit game-related content to the intake interface of the game-related network only with regard to a particular game, and only if the developer or the like is authorized to do so. Generally, one developer should not be allowed to submit content relating to the game of another developer. Typically, although not necessarily, a developer employs a submission tool to submit content to the intake interface. As may be appreciated, the submission tool may be run on a computing device of the developer and may securely access the intake interface by way of an appropriate network such as the Internet. In at least some instances, the submission tool is provided to the developer as part of a game developer kit or the like, and the developer upon establishing a relationship with the game-related network is provided with a digital certificate or other credential to signify authorization to submit game-related content to such network by way of the intake interface.

Notably, it is likely highly inefficient to have an administrator or other person manually process each package as received at the intake interface. Moreover, if manually processing each package is especially time-consuming and/or if many packages must be processed, it is to be expected that a significant delay can occur as between the time a package is received at the intake interface and the administrator or other person processes such passages. Moreover, and at any rate, with manual processing of a package, there is no set system in place that provides the submitting developer of the package with any status regarding whether the package has been processed.

Accordingly, a need exists for an automated system and method for receiving a package of game-related content from a submitting developer and for processing the package at a game-related network so as to propagate the content therein to the game-related network in an appropriate manner. Moreover, a need exists for such an automated system and method that receives and processes such a package in a reasonable amount of time. In addition, a need exists for such an automated system and method that provides the submitting developer of the package with appropriate status regarding the processing of the package.

### SUMMARY OF THE INVENTION

The aforementioned need is satisfied by the present invention in which a system and method are provided to receive content and propagate the received content to a network. In the system, an intake interface receives a package with the content from a submitter, where the package has at least one file of the content therein, and the intake interface creates a job that includes the package and places the job with the package in a jobs database.

An automated dispatcher retrieves the job from the jobs database, identifies each file of the content of the package of the job, and groups the identified files into one or more tasks. Each task has a particular type and represents a particular propagation event that can be submitted to one or more particular tools, where the files of the task represent all data required by the particular tools to perform the particular propagation event.

The automated dispatcher, for each task, calls to a propagation system with the files of the task and the particular type of the task. The propagation system includes a plurality of the particular tools and upon receiving the files and type of the task calls to one or more of the particular tools thereof to in fact perform one or more respective propagating events based on the files and type of such task to propagate the content of the job to the network. Each tool upon completing the propagating event thereof returns confirmation of such completion, where the confirmation includes status information on the propagating event as performed by the tool.

The automated dispatcher receives a return from the propagation system that the task has been completed, where the return includes the status information from each tool with regard to the task, and updates the job of the task at the jobs database with such status information from each tool. Upon determining that each task of the job has been completed, then, the automated dispatcher notifies an administrator of the network that the job is completed. The administrator thus may review the status information for the job in the jobs database and take any appropriate additional actions.

### BRIEF DESCRIPTION OF THE DRAWINGS

The foregoing summary, as well as the following detailed description of the embodiments of the present invention, will be better understood when read in conjunction with the appended drawings. For the purpose of illustrating the invention, there are shown in the drawings embodiments which are presently preferred. As should be understood, however, the invention is not limited to the precise arrangements and instrumentalities shown. In the drawings:

FIG. 1 is a block diagram representing a general purpose computer system in which aspects of the present invention and/or portions thereof may be incorporated;

FIG. 2 is a block diagram showing an automated system for receiving a package of content from a submitting developer and for processing the package at a network so as to propagate the content therein to the network in accordance with one embodiment of the present invention; and

FIG. 3 is a flow diagram showing key steps performed in connection with the system of FIG. 2 in accordance with one embodiment of the present invention.

### DETAILED DESCRIPTION OF THE INVENTION

### Computer Environment

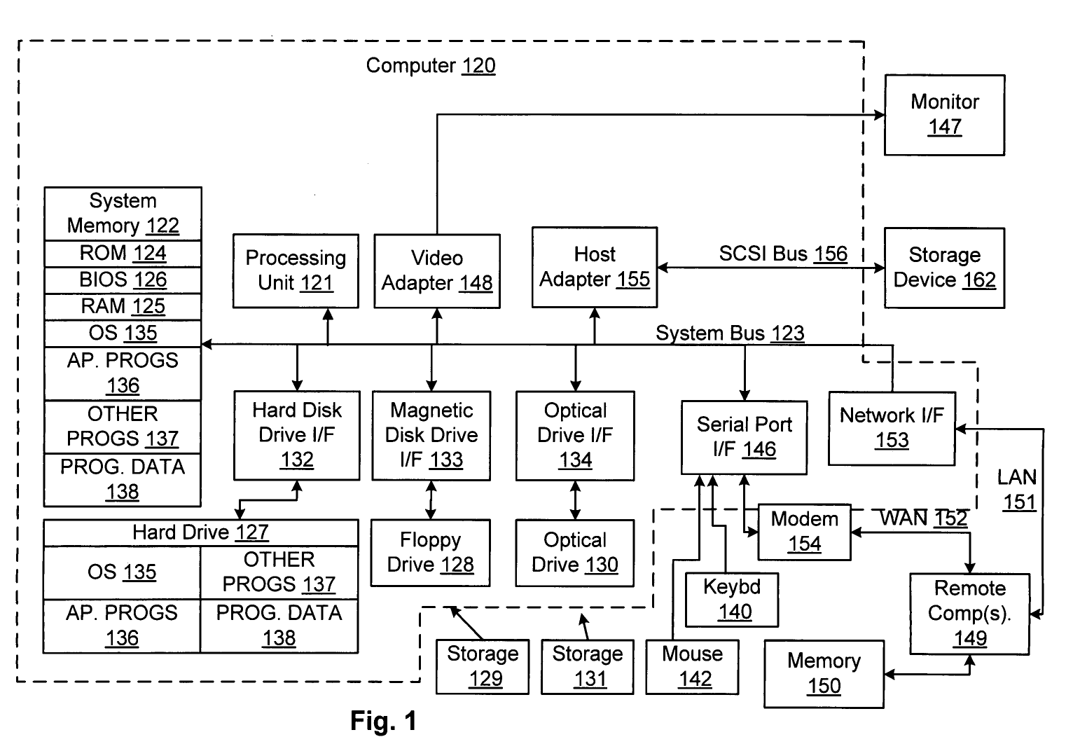

FIG. 1 and the following discussion are intended to provide a brief general description of a suitable computing environment in which the present invention and/or portions thereof may be implemented. Although not required, the invention is described in the general context of computer-executable instructions, such as program modules, being executed by a computer, such as a client workstation or a server. Generally, program modules include routines, programs, objects, components, data structures and the like that perform particular tasks or implement particular abstract data types. Moreover, it should be appreciated that the invention and/or portions thereof may be practiced with other computer system configurations, including hand-held devices, multi-processor systems, microprocessor-based or programmable consumer electronics, network PCs, minicomputers, mainframe computers and the like. The invention may also be practiced in distributed computing environments where tasks are performed by remote processing devices that are linked through a communications network. In a distributed computing environment, program modules may be located in both local and remote memory storage devices.

As shown in FIG. 1, an exemplary general purpose computing system includes a conventional personal computer 120 or the like, including a processing unit 121, a system memory 122, and a system bus 123 that couples various system components including the system memory to the processing unit 121. The system bus 123 may be any of several types of bus structures including a memory bus or memory controller, a peripheral bus, and a local bus using any of a variety of bus architectures. The system memory includes read-only memory (ROM) 124 and random access memory (RAM) 125. A basic input/output system 126 (BIOS), containing the basic routines that help to transfer information between elements within the personal computer 120, such as during start-up, is stored in ROM 124.

The personal computer 120 may further include a hard disk drive 127 for reading from and writing to a hard disk (not shown), a magnetic disk drive 128 for reading from or writing to a removable magnetic disk 129, and an optical disk drive 130 for reading from or writing to a removable optical disk 131 such as a CD-ROM or other optical media. The hard disk drive 127, magnetic disk drive 128, and optical disk drive 130 are connected to the system bus 123 by a hard disk drive interface 132, a magnetic disk drive interface 133, and an optical drive interface 134, respectively. The drives and their associated computer-readable media provide non-volatile storage of computer readable instructions, data structures, program modules and other data for the personal computer 120.

Although the exemplary environment described herein employs a hard disk, a removable magnetic disk 129, and a removable optical disk 131, it should be appreciated that other types of computer readable media which can store data that is accessible by a computer may also be used in the exemplary operating environment. Such other types of media include a magnetic cassette, a flash memory card, a digital video disk, a Bernoulli cartridge, a random access memory (RAM), a read-only memory (ROM), and the like.

A number of program modules may be stored on the hard disk, magnetic disk 129, optical disk 131, ROM 124 or RAM 125, including an operating system 135, one or more application programs 136, other program modules 137 and program data 138. A user may enter commands and information into the personal computer 120 through input devices such as a keyboard 140 and pointing device 142. Other input devices (not shown) may include a microphone, joystick, game pad, satellite disk, scanner, or the like. These and other input devices are often connected to the processing unit 121 through a serial port interface 146 that is coupled to the system bus, but may be connected by other interfaces, such as a parallel port, game port, or universal serial bus (USB). A monitor 147 or other type of display device is also connected to the system bus 123 via an interface, such as a video adapter 148. In addition to the monitor 147, a personal computer typically includes other peripheral output devices (not shown), such as speakers and printers. The exemplary system of FIG. 1 also includes a host adapter 155, a Small Computer System Interface (SCSI) bus 156, and an external storage device 162 connected to the SCSI bus 156.

The personal computer 120 may operate in a networked environment using logical connections to one or more remote computers, such as a remote computer 149. The remote computer 149 may be another personal computer, a server, a router, a network PC, a peer device or other common network node, and typically includes many or all of the elements described above relative to the personal computer 120, although only a memory storage device 150 has been illustrated in FIG. 1. The logical connections depicted in FIG. 1 include a local area network (LAN) 151 and a wide area network (WAN) 152. Such networking environments are commonplace in offices, enterprise-wide computer networks, intranets, and the Internet.

When used in a LAN networking environment, the personal computer 120 is connected to the LAN 151 through a network interface or adapter 153. When used in a WAN networking environment, the personal computer 120 typically includes a modem 154 or other means for establishing communications over the wide area network 152, such as the Internet. The modem 154, which may be internal or external, is connected to the system bus 123 via the serial port interface 146. In a networked environment, program modules depicted relative to the personal computer 120, or portions thereof, may be stored in the remote memory storage device. It will be appreciated that the network connections shown are exemplary and other means of establishing a communications link between the computers may be used.

### Submitting and Processing Content for On-Line Media Console

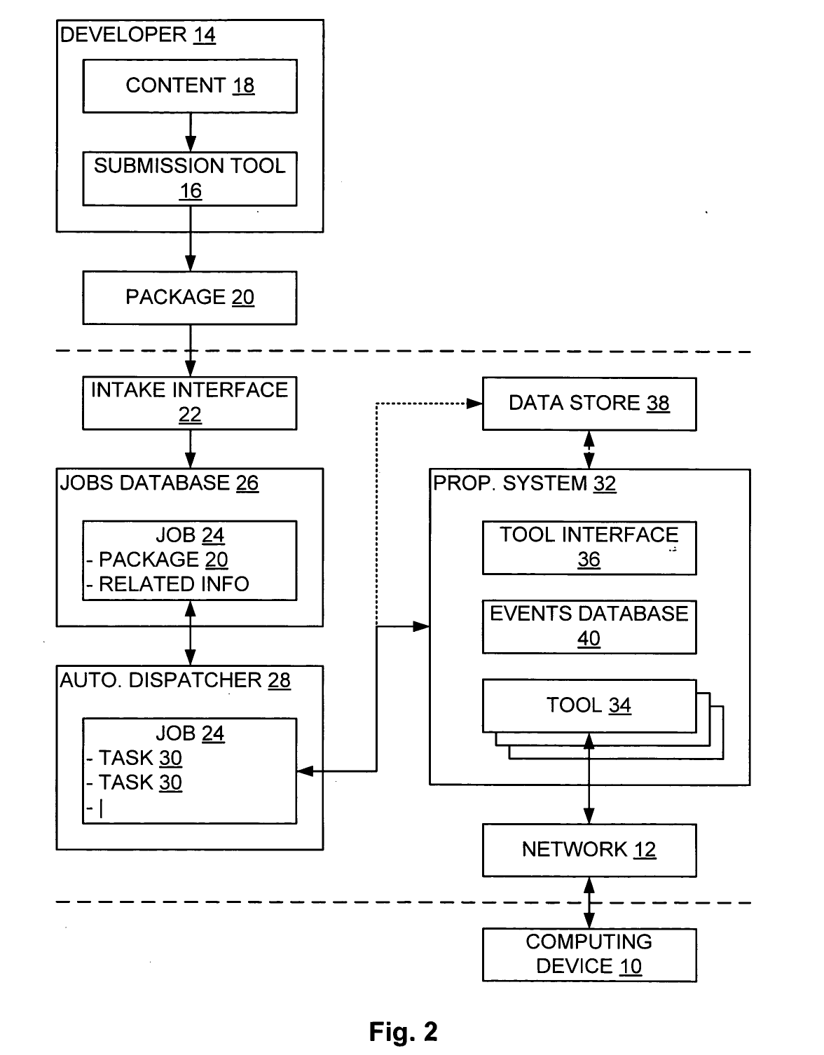

Turning now to FIG. 2, it is seen that one or more computing devices 10 (one being shown) is appropriately communicatively coupled to a network 12 or the like to implement network-based functionality for the computing device 10. As may be appreciated, such communicative coupling may be achieved by way of another network such as the Internet or the like. In one particular example, the computing device 10 is a media console such as a game-playing device or the like, the network 12 is a game-related network, and the network-based functionality relates to a game the user has instantiated at the device 10. Of course, such device 10 and network 12 may be any other appropriate network and device without departing from the spirit and scope of the present invention.

As but one example, the device 10 may be an office computing device 10 performing office functions and the network 12 may be an office-related network providing network-based functionality relating to office activities. As another example, the device 10 may be a home media computing device 10 performing home media functions and the network 12 may be a home media-related network providing network-based functionality relating to home media activities. In any case, it is to be appreciated that the network-based functionality may be any functionality without departing from the spirit and scope of the present invention, and such functionality can include providing services, providing data, and the like.

Particularly in the instance where the device 10 and network 12 are game-related, it is to be appreciated that the game may be locally instantiated at the device 10 from a source at the device 10, such as for example an optical disk with a copy of the software that the device runs to implement the game, or may be remotely instantiated at for example the network 12. In either case, the network 12 may provide content relating to the game. Such content may be any appropriate content without departing from the spirit and scope of the present invention. For example, such content may include content that implements additional game features such as personas, capabilities, levels, and the like; content ancillary to the game such as audio, video, and/or multimedia presentations that a user of the game may find interesting; content that allows a user at the device 10 to play the game with another user at another device 10 by way of the network 12; etc. Similarly, such content may be in the form of a downloadable data file, a network executable to be executed at the network 12, or the like

A developer 14 or the like may not only develop and provide the game as instantiated in connection with the device 10 but in addition may provide content relating to the game to a user thereof by way of the network 12 and the device 10. Typically, although not necessarily, the game-related content allows the user of the game to experience greater enjoyment and value in connection with such game. For example, such game-related content may include game demos, movie trailers, gamer pictures, gamer themes and in-game content such as new maps, levels, tools, weapons, equipment, functionality, and the like.

To provide the content, and still referring to FIG. 2, the developer 14 is provided with a submission tool 16 that typically runs on a computing device of the developer 14 and that receives the content 18, formats same into a package 20, and submits the package 20 to an intake interface 22 provided for the network 12 by way of an appropriate communicative coupling between the submission tool 16 and the intake interface 22. As may be appreciated, and as before, such communicative coupling may be achieved by way of another network such as the Internet or the like. Note here that such submission tool 16 and intake interface 22 may be any appropriate submission tool and intake interface without departing from the spirit and scope of the present invention. Note too that the processes performed by the submission tool 16 in packaging the content 18 into the package 20 and submitting same are generally known or should be apparent to the relevant public and therefore need not be set forth herein in any detail. Accordingly, any such processes as performed by the submission tool 16 to package and submit the content 18 may be employed without departing from the spirit and scope of the present invention.

As was set forth above, the submission tool 16 may securely access the intake interface 22 and may be provided to the developer 14 as part of a game developer kit or the like. Typically, although not necessarily, the developer 14 can submit content 18 to the intake interface 22 only with regard to a particular game, and only if the developer 14 is authorized to do so. Generally, one developer 14 should not be allowed to submit content relating to the game of another develop 14. Also typically, although not necessarily, the developer 14 upon establishing a relationship with the network 12 is provided with a digital certificate or other credential to signify authorization to submit content 18 to such network 12 by way of the intake interface 22. Thus, it may be the case that the package 20 with such content 18 is signed according to a private key corresponding to such digital certificate, and the digital certificate contains a corresponding public key that can be employed to verify such signing. Of course, any other authorizing scheme may also be employed without departing from the spirit and scope of the present invention.

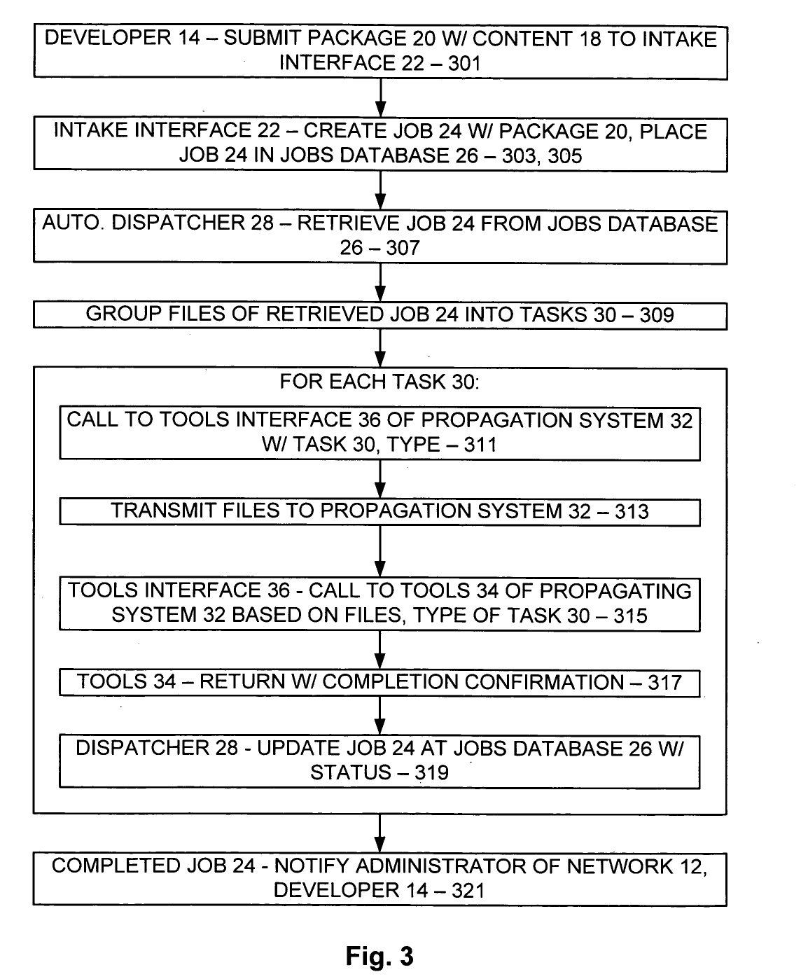

In one embodiment of the present invention, and referring to FIGS. 2 and 3, the process of receiving the content 18 and mounting or propagating the received content 18 to the network 12 is automated in the following manner and with the following elements. Preliminarily, it is to be understood that a package 20 with content 18 has been submitted by a developer 14 to the intake interface 22 (step 301), where the content 18 in the package 20 includes one or more files or the like. In response thereto, the intake interface 22 creates a job 24 that includes the package 20 and related information (step 303) and places the job 24 with the package 20 in a jobs database 26 such as that shown in FIG. 2 (step 305).

As may be appreciated, the jobs database 26 both stores the package 20 of the job 24 and also maintains and/or updates the related information. As may be appreciated, such related information may include but is not limited to when the job 24 was received, the submitting developer 14, an address to communicate with the submitting developer 14, scheduling information, tracking information, propagating information relating to how to propagate the content 18 of the package 20, and the like. Note that the content 18 within the package 20 may be in some sort of concatenated, merged, compressed, and/or other altered form, in which case such content 18 may be reorganized into an un-altered form either at the jobs database 26 or at some subsequent location.

At any rate, in one embodiment of the present invention, rather than an administrator or other person retrieving the job 24 from the jobs database 26 and manually attending to such job 24, an automated dispatcher 28 instead retrieves such job 24 from the jobs database 26 (step 307). As may be appreciated, such dispatcher 28 may retrieve the job 24 in any appropriate manner without departing from the spirit and scope of the present invention. Such retrieval should be apparent to the relevant public and therefore need not be set forth herein in any elaborate detail. For example, the dispatcher 28 may periodically query the jobs database 26 for any jobs 24 awaiting retrieval, or the jobs database 26 may in fact notify the dispatcher 28 that a job 24 is waiting to be retrieved. In either case, it may be that the job 24 includes scheduling information relating for example to a time after which the job 24 is to be processed. If so, such scheduling information should be honored by the jobs database 26 and the dispatcher 28 in an appropriate manner.

As should be appreciated, in retrieving the job 24, the dispatcher 28 may retrieve the entirety of the job 24 from the jobs database 26, only the package 20 of the job 24, or only the content 18 of the package 20 without departing from the spirit and scope of the present invention. In any event, the dispatcher 28 identifies each file or the like of the content 18 and then groups the files into one or more tasks 30 (step 309), where each task 30 represents a definable item that can be submitted to one or more particular tools, and where the files of the task 30 represent all the data needed by the particular tools to perform some sort of propagation event.

Notably, the dispatcher 28 may group the files into tasks 30 in any appropriate manner without departing from the spirit and scope of the present invention. For example, the dispatcher 28 may perform such grouping according to criteria that is in effect built in or ‘hard-wired’ into the dispatcher 29, or may perform such grouping according to criteria that is obtained from elsewhere. Notably, in grouping the files into tasks 30, the dispatcher 28 determines a particular type for each such task 30. Such typing may be performed in any particular manner without departing from the spirit and scope of the present invention. For example, such type may be derived from the grouping criteria.

At any rate, in one embodiment of the present invention a propagation system 32 is provided to include the aforementioned tools 34, and also to include a tools interface 36. For each task 30, then, the dispatcher 28 may call to the tools interface 36 of the propagation system 32 to inform same that a new task 30 of a particular type requires processing, and in response the tools interface 36 may provide a unique ID for the task 30 so that the task can be tracked (step 311). Alternatively, such unique ID may be dispensed with if not desired.

Significantly, for each task 30, the dispatcher 28 transmits the files thereof to the propagation system 32 by way of the tools interface 36 (step 313). Note that such transmission of the files of the task 30 may be performed directly from the dispatcher 28 to the propagation system 32 by way of the tools interface 36 thereof, or may be performed indirectly by way of a data store 38 interposed therebetween, as is shown in FIG. 2. As may be appreciated, the indirect approach by way of the data store 38 may be necessary and/or useful, for example if the tools interface 36 is limited in terms of communications abilities, if the tools interface 36 and the dispatcher 28 have disparate data transfer speeds, if the amount of data to be transmitted is significant, and/or if security is an issue, among other things. If indirect, the files of the task 30 may be transmitted to the data store 38, after which the dispatcher 28 notifies the tools interface 36 that the files are available and such tools interface 36 then appropriately retrieves the files from the data store 38.

Regardless of how the tools interface 36 actually obtains the files of the task 30, upon such obtaining of such files of such task 30 and with knowledge of the particular type of such task 30, such tools interface 36 calls to one or more particular tools 34 of the propagation system 32 to in fact perform one or more respective propagating events based on the files of such task 30 (step 315), and each tool 34 upon completing the propagating event thereof returns confirmation of such completion to the tools interface 36 (step 317). As may be appreciated, the particular tools 34 and propagating events performed thereby are known or should be apparent to the relevant public and therefore need not be set forth herein in any detail. For example, one tool 34 may simply place one or more particular files 34 at a particular location without any transformation on such files 34, while another tool 34 may first perform some sort of transformation on the one or more files 34 before placing the result at one or more particular locations. Similarly, yet another tool 34 may execute a particular file 34 at the network 12 to transform a portion of the network 12 in a particular manner. Accordingly, such tools 34 and propagating events may be any tools and events without departing from the spirit and scope of the present invention.

In one embodiment of the present invention, the propagation system 32 includes an events database 40 that specifies details on which particular tools 34 to call and how based on the type of a task 30. Thus, the tools interface 36 in calling to one or more of the particular tools 34 as at step 315 performs such calls according to the type of the task 30 and after referring to the events database 40 based on same. Note too, that such events database 40 may also be consulted by the dispatcher 28 in the course of grouping files into tasks 30 as at step 309.

Note that in the course of each tool 34 returning confirmation of completion to the tools interface 36 as at step 317, and bearing in mind that some form of error or failure could possibly have occurred, the confirmation from such tool 34 may include some form of status. Such forms of status may be any appropriate forms without departing from the spirit and scope of the present invention. For example, and as may be appreciated, such forms of status can include but are not limited to completed successfully, completed with failures, completed with errors, not completed, and the like. With such status, then, and in one embodiment of the present invention, as the propagation system 32 is operating based on each task 30 of the job 24, the dispatcher 28 periodically queries the tools interface 36 to determine whether the task 30 has been completed. Significantly, when the task 30 is in fact completed, the tools interface 36 may return an appropriate response that includes the status of each tool 34 that performed a propagating event in connection with the task 30, and the dispatcher 28 updates the job 24 of the task 30 at the jobs database 26 with such status (step 319).

As may now be appreciated, the dispatcher 28 waits until some form of completion status is received for all tasks 30 of the job 24 and the jobs database 26 is appropriately updated as at step 319. Thereafter, and in one embodiment of the present invention, the dispatcher 28 notifies an administrator of the network 12 or other person that the job 24 is completed, and also notifies the developer 14 that submitted the package 20 of the job 24 that the job is completed (step 321). Each notification may include the completion status of all the tasks 30 of the job 24. Notably, if the job 24 as shown by such completion status resulted in errors or failures or the like, the administrator or other person and/or the developer 14 can take appropriate steps to rectify whatever problems may have arisen. For example, a particular task 30 may be manually resubmitted, or the entire job may be manually resubmitted if necessary, perhaps after some modification to the content 18 relating thereto.

As may now be appreciated, the dispatcher 28 of the present invention in general operates to periodically determine whether the jobs database 26 has any jobs 24 with content 18 to be propagated to the network 12, and if so to in fact so propagate. Notably, the dispatcher 28 is operable to handle a job 24 resulting from a package 20 from a developer 14 and also to handle a job 24 manually entered by an administrator or other person. In the latter case, and as may be appreciated, the manually entered job 24 may be a test job 24, an administrative job 24, or any other appropriate network-related job 24.

Note that in the course of handling multiple jobs 24 from one or more developers 14, it may be the case that the dispatcher 28 schedules the jobs 24 according to specific scheduling information associated with each job 24 and/or external scheduling criteria not associated with any particular job 24. For example, scheduling may take place at least partially according to when the job 24 was entered into the jobs database 26, among other things.

As set forth above, the dispatcher 28 understands how to correctly sort files of a job 24 into tasks 30 them and group them in their correct order. For example, the dispatcher 28 may perform such sorting algorithmically to match related files. Especially in the event where tasks 30 of a job 24 have only partially been propagated prior to the job 24 being withdrawn, the dispatcher 28 understands how to propagate only those tasks 30 that remain to be propagated if and when the job 24 is reactivated, without re-propagating tasks 30 that have already been completed. Generally, to do so, the dispatcher 28 tracks in the jobs database 26 for each job 24 which tasks 30 have and have not been successfully completed. The dispatcher 28 may also itself maintain a log of the tasks 30 and also may provide self-monitoring by itself submitting a test job 24 to the jobs database 26, for example once every hour. If the test job 24 fails, then, the dispatcher 28 or an analogous entity may then alert an administrator or other person or entity the dispatcher 28 is inoperative or malfunctioning.

### Conclusion

The programming necessary to effectuate the processes performed in connection with the present invention is relatively straight-forward and should be apparent to the relevant programming public. Accordingly, such programming is not attached hereto. Any particular programming, then, may be employed to effectuate the present invention without departing from the spirit and scope thereof.

In the foregoing description, it can be seen that the present invention comprises a new and useful automated system and method for receiving a package 20 of game-related content 18 or the like from a submitting developer 14 or the like and for processing the package 20 at a game-related network 12 or the like so as to propagate the content 18 therein to the game-related network 12 or the like in an appropriate manner. The automated system and method receives and processes such a package 20 in a reasonable amount of time, and provides the submitting developer 14 or the like of the package 20 with appropriate status regarding the processing of the package 20.

It should be appreciated that changes could be made to the embodiments described above without departing from the inventive concepts thereof. For example, although the present invention has been set forth herein in terms of a game-based network 12, such network 12 may instead be any other network 12 without departing from the spirit and scope of the present invention. It should be understood, therefore, that this invention is not limited to the particular embodiments disclosed, but it is intended to cover modifications within the spirit and scope of the present invention as defined by the appended claims.

1. A method of receiving content and propagating the received content to a network, the method comprising:
receiving a package with the content from a submitter, the package having at least one file of the content therein;
creating a job that includes the package and placing the job with the package in a jobs database;
retrieving, by an automated dispatcher, the job from the jobs database, the automated dispatcher:
identifying each file of the content of the package of the job and grouping the identified files into one or more tasks, each task having a particular type and representing a particular propagation event that can be submitted to one or more particular tools, the files of the task representing all data required by the particular tools to perform the particular propagation event;
for each task:
calling to a propagation system with the files of the task and the particular type of the task, the propagation system including a plurality of the particular tools and upon receiving the files and type of the task calling to one or more of the particular tools thereof to in fact perform one or more respective propagating events based on the files and type of such task to propagate the content of the job to the network, each tool upon completing the propagating event thereof returning confirmation of such completion, the confirmation including status information on the propagating event as performed by the tool;
receiving a return from the propagation system that the task has been completed, the return including the status information from each tool with regard to the task; and
updating the job of the task at the jobs database with such status information from each tool; and
upon determining that each task of the job has been completed, notifying an administrator of the network that the job is completed, whereby the administrator may review the status information for the job in the jobs database and take any appropriate additional actions.

2. The method of claim 1 comprising receiving the package at an intake interface, the intake interface creating the job including the package in the jobs database.

3. The method of claim 1 comprising creating the job including the package and placing the job with the package and related information in the jobs database, the related information being at least partially updated and/or maintained by the jobs database and including at least one of when the job was received, the submitter, an address to communicate with the submitter, scheduling information, tracking information, and propagating information relating to how to propagate the content of the package.

4. The method of claim 1 comprising the automated dispatcher retrieving the job from the jobs database after periodically querying the jobs database for any jobs awaiting retrieval.

5. The method of claim 1 comprising, for each task, the dispatcher transmitting the files of the task to the propagation system by way of a data store interposed between the dispatcher and the propagation system.

6. The method of claim 1 wherein the propagation system includes an events database specifying details on which particular tools to call and how based on the type of each task, the method comprising, for each task, the propagation system calling to one or more of the particular tools thereof according to the type of the task and after referring to the events database.

7. The method of claim 1 wherein the propagation system includes an events database specifying details on which particular tools to call and how based on the type of each task, the method comprising the dispatcher grouping the identified files into one or more tasks, each task having a particular type, in consultation with the events database of the propagations system.

8. The method of claim 1 comprising the dispatcher receiving status information including whether each task completed successfully, completed with errors, and did not completed.

9. The method of claim 1 comprising, for each task, the dispatcher periodically querying the propagation system to determine whether the task has been completed.

10. The method of claim 1 further comprising the dispatcher, upon determining that each task of the job has completed, notifying the submitter that the job is completed.

11. A system for receiving content and propagating the received content to a network, the system comprising:
an intake interface for receiving a package with the content from a submitter, the package having at least one file of the content therein;
a jobs database, the intake interface creating a job that includes the package and placing the job with the package in the jobs database;
an automated dispatcher for retrieving the job from the jobs database, identifying each file of the content of the package of the job and grouping the identified files into one or more tasks, each task having a particular type and representing a particular propagation event that can be submitted to one or more particular tools, the files of the task representing all data required by the particular tools to perform the particular propagation event; and
a propagation system, the automated dispatcher for each task calling to the propagation system with the files of the task and the particular type of the task, the propagation system including a plurality of the particular tools and upon receiving the files and type of the task calling to one or more of the particular tools thereof to in fact perform one or more respective propagating events based on the files and type of such task to propagate the content of the job to the network, each tool upon completing the propagating event thereof returning confirmation of such completion, the confirmation including status information on the propagating event as performed by the tool;
the automated dispatcher for receiving a return from the propagation system that the task has been completed, the return including the status information from each tool with regard to the task, and updating the job of the task at the jobs database with such status information from each tool; and
the automated dispatcher for, upon determining that each task of the job has been completed, notifying an administrator of the network that the job is completed, whereby the administrator may review the status information for the job in the jobs database and take any appropriate additional actions.

12. The system of claim 11 wherein the intake interface creates the job that includes the package and placing the job with the package and related information in the jobs database, the related information being at least partially updated and/or maintained by the jobs database and including at least one of when the job was received, the submitter, an address to communicate with the submitter, scheduling information, tracking information, and propagating information relating to how to propagate the content of the package.

13. The system of claim 11 wherein the automated dispatcher retrieves the job from the jobs database after periodically querying the jobs database for any jobs awaiting retrieval.

14. The system of claim 11 further comprising a data store interposed between the dispatcher and the propagation system, wherein, for each task, the dispatcher transmits the files of the task to the propagation system by way of the data store.

15. The system of claim 11 wherein the propagation system includes an events database specifying details on which particular tools to call and how based on the type of each task, and wherein, for each task, the propagation system calls to one or more of the particular tools thereof according to the type of the task and after referring to the events database.

16. The system of claim 11 wherein the propagation system includes an events database specifying details on which particular tools to call and how based on the type of each task, wherein the dispatcher groups the identified files into one or more tasks, each task having a particular type, in consultation with the events database of the propagations system.

17. The method of claim 1 wherein the dispatcher receives status information including whether each task completed successfully, completed with errors, and did not completed.

18. The system of claim 1 wherein, for each task, the dispatcher periodically queries the propagation system to determine whether the task has been completed.

19. The system of claim 1 wherein the dispatcher, upon determining that each task of the job has completed, notifies the submitter that the job is completed.

20. The system of claim 1 further comprising a submission tool running on a computing device of the submitter and being employed by the submitter to receive the content and produce the package therefrom, the submission tool securely accessing the intake interface to transmit the package thereto.
